(19) United States
(12) Patent Application Publication
(10) Pub. No.: US 2010/0265473 A1
(43) Pub. Date: Oct. 21, 2010

(54) Projection Device

(75) Inventors: Reiko Yamashita, Gifu (JP); Yoshihiro Nishimura, Gifu (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/744,520

(22) PCT Filed: Nov. 26, 2008
(86) PCT No.: PCT/JP2008/071451

§ 371 Date: May 26, 2010

(30) Foreign Application Priority Data
Nov. 28, 2007 (JP) 2007-308039

(51) Int. Cl. G03B 21/14

(52) U.S. Cl. 353/85

(57) ABSTRACT

[Object]To provide a scan-type projection device that can lengthen a projecting time during a battery-powered operation.

[Constitution] If a battery 600 is sufficiently charged, an actuator control part 120 drives a movable mirror 43 so as to form a normal turning angle, and an image signal processing part 130 drives a light source part 41 so as to irradiate laser lights with predetermined gradations to one pixel region for a normal irradiation time t1. Accordingly, an image with a normal screen size is displayed on a projection plane. Meanwhile, if the battery becomes low in remaining level, the actuator control part 120 drive the movable mirror 43 so as to form a small turning angle, and the image signal processing part 130 drives the light source part 41 so as to irradiate laser lights with predetermined gradations to one pixel region for a short irradiation time t2. Accordingly, an image with a reduced screen size is displayed on a projection plane.

### TECHNICAL FIELD

The present invention relates to a projection device, and is suitable particularly for use in a scanning-type projection device that projects an image by scanning a projection plane with light.

### BACKGROUND ART

As a general projection device (hereinafter referred to as “projector”), there is a known scanning-type projector that has three laser lights of red, green, and blue as a light source, and scans a projection plane with these laser lights using a movable mirror composed of micro electro mechanical systems (MEMS) and the like to thereby projects a color image (Patent Document 1). Such a projector can be reduced in size and lowered in power consumption, and therefore incorporating the projector into small-sized devices such as mobile phones has been considered in recent years.

For example, a mobile phone has a display part (liquid crystal display) that is made significantly small in dimensions due to its size limit as compared with a personal computer. It is therefore hard to use an existing mobile phone for the purpose of viewing pictures or showing materials for presentation. To address this, incorporating a small-sized projector into a mobile phone would makes it possible to project an image onto a wall or the like as appropriate and produce a screen display with dimensions closer to a personal computer. This widens the range of application of a mobile phone.

### Patent Document 1: JP 2006-330583 A

### DISCLOSURE OF THE INVENTION

### Problem to be Solved by the Invention

If a projector is incorporated into a mobile phone, the projector is often driven by a battery in the mobile phone. Accordingly, in the case of such a battery-operated projector, it is desired to reduce power consumption to lengthen an operating time (projecting time).

The present invention has been devised in light of the foregoing problem, and an object of the present invention is to provide a scanning-type projection device with a long projecting time as much as possible at a battery-powered operation.

### Means to Solve the Problem

A projection device in a first aspect of the present invention includes: a light source part; a scan part for scanning a projection plane with light emitted from the light source part; a light source control part for driving the light source part in accordance with an image signal; a scan control part for driving the scan part; and a remaining battery level determination part for determining a remaining level of a battery as a power source. When the remaining battery level determination part determines that the remaining level of the battery has lowered to a first predetermined level, the light source control part and the scan control part control driving of the light source part and the scan part so as to reduce a size of a screen projected onto the projection plane.

According to the projection device of this aspect, when the battery becomes low in remaining level, the projection screen is decreased in size and an amount of light to be irradiated to the projection screen is reduced. This makes it possible to reduce power consumption at the light source part and lengthen a subsequent projecting time.

In the projection device of this aspect, the scan control part may be configured to, when the battery becomes low in remaining level to the first predetermined level, narrow a scan range in correspondence with a decreased screen size. In this case, the light source control part may be configured to drive the light source part so as to decrease the amount of light irradiated to each pixel region in a projection image of the reduced screen size.

Accordingly, it is possible to suppress power consumption at the light source part in a more efficient manner. As a scan range is narrowed in accordance with a screen size reduction, an area of one pixel region becomes smaller as compared with a pre-reduction area. Accordingly, when one pixel region becomes smaller in area, it is possible to suppress the amount of light to be irradiated to one pixel required for maintaining brightness at the same level as that of the pre-reduction area. Therefore, even if the amount of light irradiated to each of the pixel regions is suppressed in accordance with a screen size reduction as stated above, the projected screen can be maintained the brightness at an almost equal level as before the size reduction.

Further, in this configuration, the light source control part may be configured to reduce the amount of light irradiated to the pixel region, in accordance with a degree of reduction in area of the pixel region and a degree of shortening of a time required for scanning one screen by narrowing the scan range.

As described above, by controlling the amount of light irradiated to the pixel region in consideration of the degree of reduction of each of the pixel regions and the degree of shortening of the time required for scanning one screen, it is possible to suppress power consumption at the light source part in a further efficient manner. Specifically, if the speed of scanning by the scan part is equal between before and after a screen size reduction, the time required for scanning one screen become shorter with a decrease in scan range. During the projection, light scanning is repeated for each screen. In this case, when the time required for scanning one screen becomes shorter, a time interval from when light comes to one pixel region and to when light returns to the same pixel region also becomes shorter accordingly. Consequently, if the amount of light irradiated at a time to each of the pixels is the same as a conventional case, a projected image feels brighter to a viewer. Therefore, in the case of a screen size reduction, even if the amount of light irradiated to one pixel region is suppressed, it is possible to project an image with brightness at almost the same level as before the size reduction. Accordingly, by decreasing the amount of light irradiated to the pixel region in consideration of the degree of reduction of each of the pixel regions and the degree of shortening a time required for scanning one screen, it is possible to reduce power consumption at the light source part in an effective manner while maintaining the brightness of a projected screen at an equal level between before and after the screen size reduction.

Further, in the projection device of this aspect, the light source control part and the scan control part may be configured to drive the light source part and the scan part so as to display a portion of a full-sized image in the screen region of a reduced size. Here, the full-sized image means a whole image before partial cutout. Specifically, the full-sized image refers to a whole image of a normal screen size before size reduction.

In this case, the scan control part may be configured to drive the scan part so as to make a light scan range on the projection plane equal between before and after the screen size reduction. The light source control part may be configured to, after the screen size reduction, drive the light source part only with a timing corresponding to the reduced screen. This eliminates the need to make a change to drive control of the scan part, thereby resulting in a simplified control operation.

Further, in the projection device of this aspect, the light source part may be configured to emit a plurality of color lights; the scan part may be configured to scan the projection plane with the plurality of color lights emitted from the light source part to thereby project an image of a screen size in accordance with the scan range onto the projection plane; and the light source control part may be configured to, when the remaining battery level determination part determines that the battery has lowered in remaining level to a second predetermined level lower than the first predetermined level, drive the light source part so as to decrease the number of the color lights for scanning the projection plane.

According to the foregoing configuration, when the battery becomes low in remaining level, numerical limitation is set to the color lights, and therefore projection is carried out with a decreased number of color light (s) (e.g. one color), which makes it possible to further reduce power consumption at the light source part.

In this configuration, the projection device may be configured to further include a selection control part to select color light (s) for scanning the projection plane from among the plurality of color lights. In this case, for example, the selection control part may select such color light (s) by a user's operation or in accordance with a result of analysis of color (s) contained in an image to be projected. Alternatively, the selection control part may select color light(s) in accordance with colors of a projection plane shot by an imaging device. Accordingly, it is possible to project an image with color (s) in accordance with image state, projection plane state, user's preferences, and the like, and to carry out projection in a favorable condition as much as possible even with a decreased number of color(s).

In an embodiment described below, a movable mirror 43 corresponds to the “scan part” in the present invention; an actuator control part 120 corresponds to the “scan control part” in the present invention; and an image signal processing part 130 corresponds to the “light source control part” and the “selection control part” in the present invention.

### ADVANTAGE OF THE INVENTION

According to the present invention as stated above, it is possible to lengthen a projecting time at a battery-powered operation.

Advantage or significance of the present invention will be further understood from the description of an embodiment below. However, the following embodiment is merely an example for carrying out the present invention, and the present invention is not limited by the following embodiment.

### BRIEF DESCRIPTION OF THE DRAWINGS

FIG. 1 is a diagram showing an external configuration of a mobile phone in an embodiment;

FIG. 2 is a diagram showing a configuration of a projector module in the embodiment;

FIG. 3 is a functional block diagram showing a configuration of the mobile phone in the embodiment;

FIG. 4 is a functional block diagram showing a configuration associated with driving of the projector module in the embodiment;

FIG. 5 is a diagram for describing a scan state of laser lights and an output state of laser lights irradiated onto a projection screen in the embodiment;

FIG. 6 is a diagram showing schematically a timing for driving an actuator and a timing for driving a laser in the embodiment;

FIG. 7 is a diagram showing output states of laser lights in a normal screen and a reduced screen in the embodiment;

FIG. 8 is a flowchart showing a specific control operation for reducing power consumption at the projector module in the embodiment;

FIG. 9 is a diagram for describing another configuration for adjusting amounts of emission of laser lights in the embodiment;

FIG. 10 is a diagram for describing still another configuration for adjusting amounts of emission of laser lights in the embodiment;

FIG. 11 is a diagram for describing another configuration for reducing a size of the projection screen in the embodiment;

FIG. 12 is a flowchart showing a specific control operation in the configuration of FIG. 11; and

FIG. 13 is a functional block diagram showing another configuration associated with driving of the projector module in the embodiment.

However, the attached drawings are intended only for illustration and do not limit the scope of the present invention.

### BEST MODE FOR CARRYING OUT THE INVENTION

An embodiment of the present invention will be described below with reference to the attached drawings. In this embodiment, a projection device of the present invention is applied to a mobile phone.

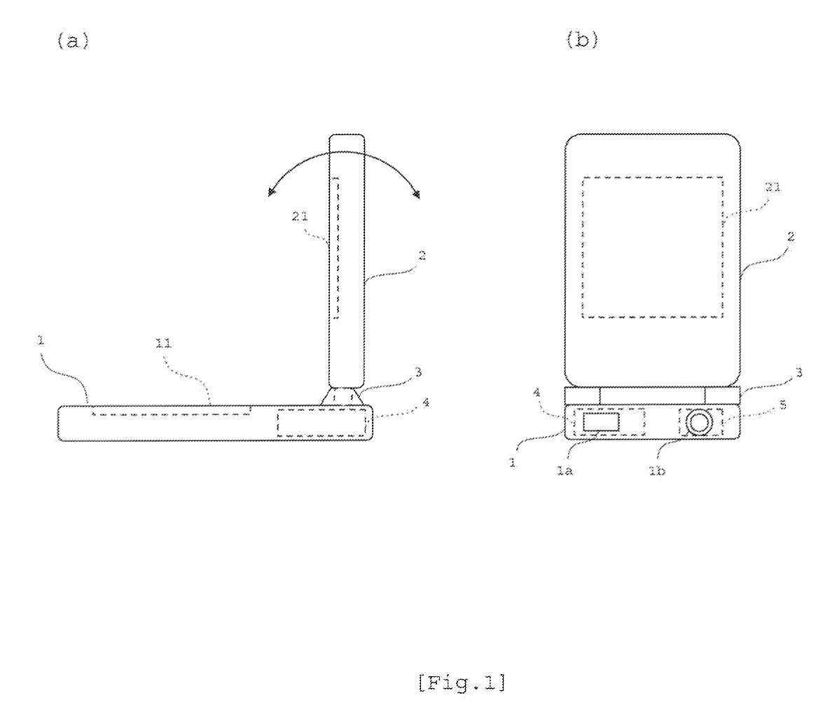

FIG. 1 is a diagram showing an external configuration of the mobile phone: FIG. 1 (a) is a side view of the mobile phone with a display part 2 made upright in an almost vertical position with respect to an operation part 1; and FIG. 1 (b) is a rear view of the mobile phone in the same state.

The mobile phone includes the operation part 1 and the display part 2. The operation part 1 has a keypad 11 disposed on a front side thereof. The keypad 11 includes various keys such as a key for switching among various modes (camera shooting mode, e-mail send/receive mode, Internet mode, and projector mode), a call start key, a call end key, number/character input keys, and others. The display part 2 has a liquid crystal display 21 on a front side thereof. The display part 2 is rotatably coupled via a hinge part 3 to the operation part 1. Accordingly, the mobile phone can be folded between the operation part 1 and the display part 2 such that the keypad 11 and the liquid crystal display 21 are opposed to each other. In addition, the mobile phone can be unfolded between the operation part 1 and the display part 2 such that the keypad 21 and the liquid crystal display 21 are oriented in almost the same direction.

The operation part 1 has a projector module 4 and a camera module 5 inside near the hinge part 3. In addition, the operation part 1 has on an end surface near the hinge part 3, a projection window 1a for passing and emitting laser light from the projector module 4 and a lens window 1b for capturing an image of an object into the camera module 5.

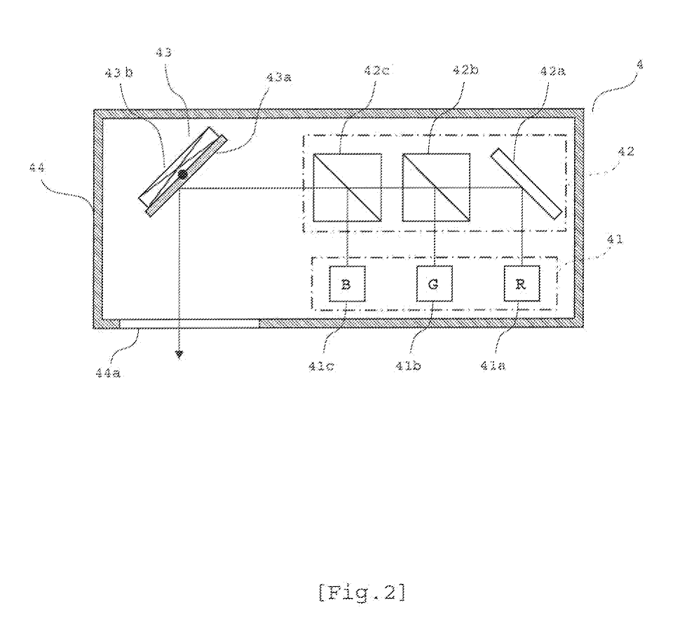

FIG. 2 is a diagram showing a configuration of the projector module 4. The projector module 4 includes a light source part 41, a light guide optical system 42, and the movable mirror 43. The light source part 41, the light guide optical system 42, and the movable mirror 43 are housed in a case 44.

The light source part 41 emits three laser lights of red, green, and blue. Accordingly, the light source part 41 includes a red laser portion 41a, a green laser portion 41b, and a blue laser portion 41c. The red laser portion 41a emits a red laser light (hereinafter referred to as “R light”); the green laser portion 41b emits a green laser light (hereinafter referred to as “G light”); and the blue laser portion 41c emits a blue laser light (hereinafter referred to as “B light”).

The light guide optical system 42 is composed of a reflective mirror 42a and two dichroic mirrors 42b and 42c. The dichroic mirror 42b reflects G light and lets R light through. The dichroic mirror 42c reflects B light and lets R and G lights through.

The R light emitted from the red laser portion 41a is reflected on the reflective mirror 42a and is bent about 90 degrees. Then, the R light passes through the two dichroic mirrors 42b and 42c and enters the movable mirror 43. In addition, the G light emitted from the green laser portion 41b is reflected on the dichroic mirror 42b and is bent about 90 degrees. Then, the G light passes through the dichroic mirror 42c and enters the movable mirror 43. In addition, the Blight emitted from the blue laser portion 41c is reflected on the dichroic mirror 42c and is bent about 90 degrees, and then enters the movable mirror 43.

The movable mirror 43 is composed of micro electro mechanical systems (MEMS), and includes a mirror 43a and an actuator 43b. The actuator 43b is a biaxial type and rotates the mirror 43a in a two-dimensional direction with the use of driving force such as an electromagnetic force, a piezoelectric element, an electrostatic force, or the like.

The R, G, and B lights having entered the mirror 43a of the movable mirror 43 are reflected in a direction in accordance with an angle of turning of the mirror 43a. When the mirror 43a is turned by the actuator 43b in a two-dimensional direction, a projection plane is scanned two-dimensionally with the R, G and B lights. Accordingly, an image is projected with a combination of the R, G, and B lights onto the projection plane.

The case 44 is made from a metal material for an enhanced heat radiation property. The case 44 has a projection opening 44a for passing laser light reflected on the movable mirror 43 and guiding the same to the projection window 1a (see FIG. 1(b)).

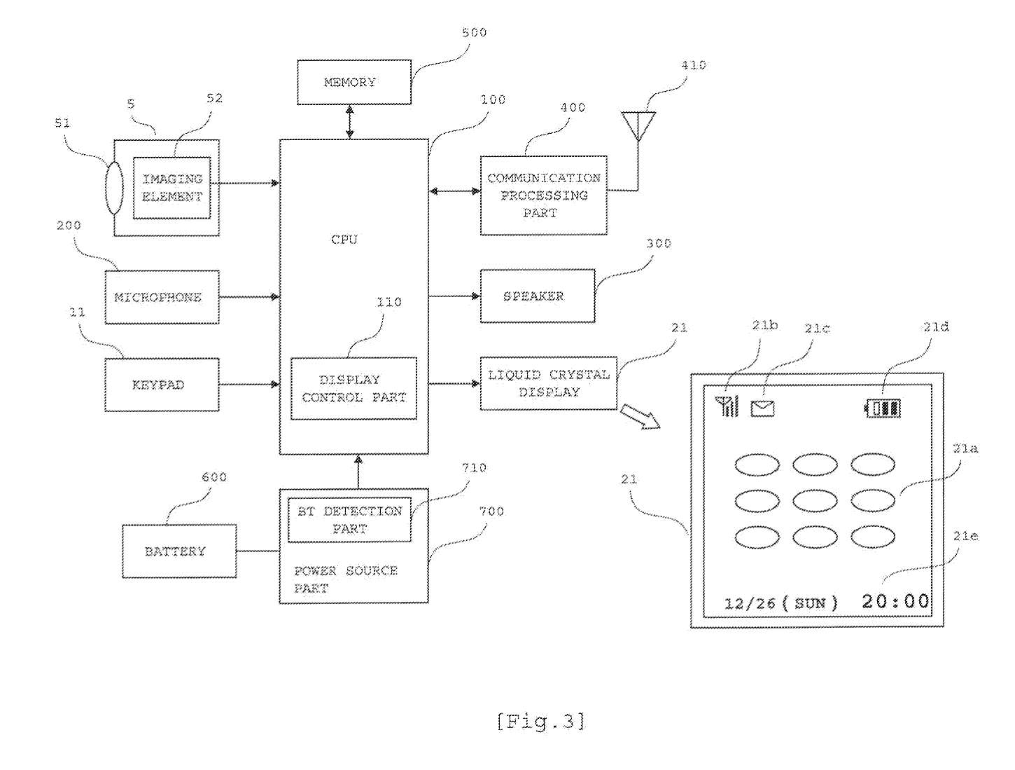

FIG. 3 is a functional block diagram showing a configuration of the mobile phone. In FIG. 3, the projector module 4 and a configuration relating to driving of the projector module 4 (described later) are omitted.

The mobile phone includes the keypad 11, the liquid crystal display 21, and the camera module 5 as described above with reference to FIG. 1, and also includes a CPU 100, a microphone 200, a speaker 300, a communication processing part 400, a memory 500, a battery 600, and a power source part 700.

The camera module 5 is composed of an imaging lens 51, an imaging element 52, and the like.

The imaging lens 51 forms an image of an object on the imaging element 52. The imaging element 52 is formed by a CCD, for example, and generates an imaging signal in accordance with a captured image and sends the same to the CPU 100.

The microphone 200 converts an audio signal into an electric signal and sends the same to the CPU 100. The speaker 300 reproduces the audio signal from the CPU 100 in audio representation.

The communication controlling part 400 converts audio signals, image signals, text signals and the like, from the CPU 100 into radio signals, and transmits the same to a base station via an antenna 410. The communication processing part 400 also converts radio signals received via the antenna 410 into audio signals, image signals, text signals and the like, and sends the same to the CPU 100.

The memory 500 stores image data shot by the camera module 5, image data captured from the outside via the communication processing part 400, text data (e-mail data) and the like, in predetermined file formats.

The battery 600 is intended to supply power to the CPU 100 and other components of the mobile phone, and is formed by a secondary battery. The battery 600 is connected to the power source part 700.

The power source part 700 converts a voltage of the battery 600 into voltages of magnitudes required for the components of the mobile phone, and supplies the same to the components. In addition, the power source part 700 charges the battery 600 by supplying the battery 600 with power supplied from an input of an external power source (not shown).

The power source part 700 has a battery voltage detection part 710 (hereinafter referred to as “BT detection part”). The BT detection part 710 detects a voltage of the battery 600 and sends the same to the CPU 100.

The CPU 100 outputs control signals to the components such as the speaker 300 and the liquid crystal display 21, in accordance with input signals from the components such as the keypad 11, the microphone 200, and the imaging element 52, to thereby carry out communication processing and various mode operations.

The CPU 100 includes a display control part 110. The display control part 110 produces an image to be displayed on the liquid crystal display 21, in a memory (not shown) as a working area prepared in the CPU 100, and outputs a drive signal for displaying the produced image to the liquid crystal display 21. The liquid crystal display 21 then shows the image in accordance with the drive signal.

An example of a screen display on the liquid crystal display 21 is provided in the lower right part of FIG. 3. This screen is a mode selection screen and has an image 21a for mode selection as a main display in the center thereof. In addition, the screen also has an image 21b indicative of an antenna reception status, an image 21c indicative of incoming e-mail message(s), and an image 21d indicative of a remaining battery level, as sub displays, on an upper part thereof. The screen has an image 21e indicative of the date on the lower part thereof.

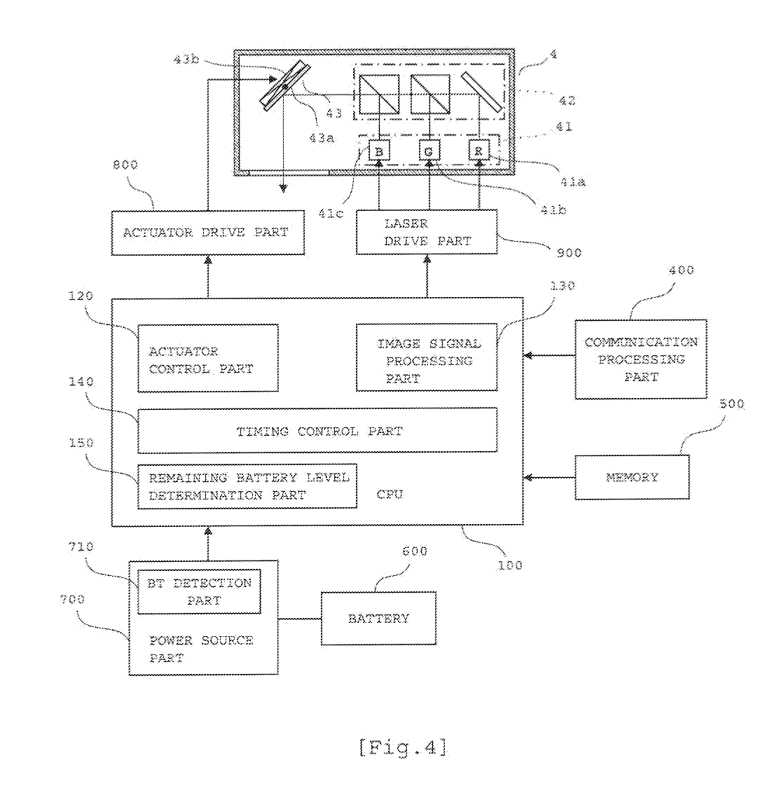

FIG. 4 is a functional block diagram showing a configuration relating to driving of the projector module 4 in the mobile phone. In FIG. 4, the components not relating to driving control of the projector module 4 in the configuration of FIG. 3 described above, are omitted.

The mobile phone further includes an actuator drive part 800 and a laser drive part 900. In addition, the CPU 100 includes an actuator control part 120, an image signal processing part 130, a timing control part 140, and a remaining battery level determination part 150.

The actuator control part 120 controls driving of the actuator 43b in the movable mirror 43, and outputs a control signal to the actuator drive part 800 with a predetermined drive timing. In accordance with the control signal, the actuator drive part 800 outputs a drive signal to the actuator 43b.

The image signal processing part 130 controls driving of the light source part 41. The image signal processing part 130 captures image data stored in the memory 500, image data received via the communication processing part 400, and others. Then, the image signal processing part 130 generates an RGB signal from the captured image data, and outputs the generated RGB signal to the laser drive part 900 with a predetermined drive timing. In accordance with the RGB signal, the laser drive part 900 outputs a drive signal to the red laser portion 41a, the green laser portion 41b, and the blue laser portion 41c in the light source part 41.

The timing control part 140 adjusts a timing for driving the actuator 43b by the actuator control part 120 and a timing for driving the light source part 41 by the image signal processing part 130. The remaining battery level determination part 150 determines a voltage level of the battery 600, that is, a remaining level of the battery 600, based on a voltage of the battery 600 detected by the BT detection part 610. As a matter of course, power is also supplied from the battery 600 to the components relating to driving of the projector module 4.

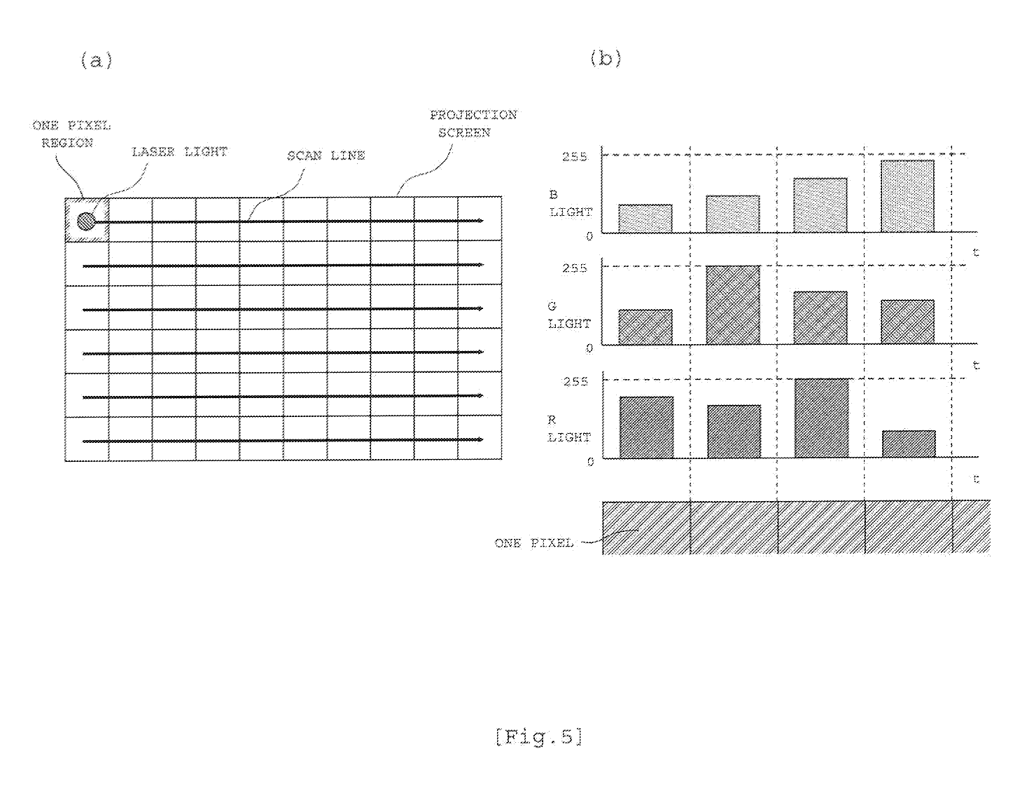

FIG. 5 is a diagram for describing a projection screen produced by the projector module 4 and an output state of laser lights irradiated onto the projection screen: FIG. 5 (a) is a diagram showing a scan state of the laser lights for producing the projection screen; and FIG. 5 (b) is a diagram showing an output state of the laser lights in pixel regions. In FIG. 5 (b), vertical axes indicate gradations of the laser lights (magnitudes of laser power), and horizontal axes indicate irradiation times of the laser lights.

As shown in FIG. 5 (a), when the mirror 43a is turned by the actuator 43b, horizontal scanning is performed using the laser lights (R, G, and B lights). The laser light scanning is carried out only according to the number of horizontal pixels as shown by solid line arrows (scan lines) in FIG. 5 (a). The mirror 43a is turned in such a manner that, upon completion of a one-line scan, the laser lights come to a start point of a next scan line. In the same manner, laser light scanning is subsequently carried out in the horizontal direction and then the mirror 43a is turned so as to set a radiation position of the laser lights at a start point of a next scan line. The scan lines exist in correspondence with the number of vertical pixels. The mirror 43a is turned in such a manner that, upon completion of scanning in a lowermost scan line, the laser lights come to a start point of an uppermost scan line. Accordingly, one cycle of scanning is now completed for one screen, and then such a scanning operation is repeated during projection. A spot size of laser light is set smaller than a size of one pixel in a normal screen size.

As shown in FIG. 5 (b), while laser power is adjusted as corresponding to proper gradation for each of the pixel regions, the laser lights are irradiated for a predetermined period of time for each of the pixel regions. At that time, the color of one pixel region is determined in accordance with the laser light gradations. The gradations of the laser lights are each adjusted by a magnitude of laser power. In this embodiment, the gradations are provided in 256 levels. In addition, the brightness (light intensity) of one pixel region is adjusted by a total amount of laser lights applied to the pixel region, that is, an irradiation time of the laser lights. Even if the irradiated lights are unchanged in intensity, the projected image feels brighter to a viewer with an increased irradiation time (an increased total amount of lights).

In such a manner as stated above, the projection plane is scanned with three laser lights with gradations changed for each pixel region, to thereby display an intended picture (still image or moving image) on the projection screen. The projection plane is not scanned with the laser lights simultaneously, but is scanned with R light, G light, and B light in orderly sequence for each screen, for example. Even if scanning is performed with the laser lights in a sequential manner, one scanning operation is completed in an extremely short time, and therefore the projected image appears as one color picture with a combination of three colors, in the eyes of a viewer by persistence of vision. As a matter of the course, alternatively, R light, G light and B light may be emitted simultaneously and combined at the light guide optical system 42, and then enter the movable mirror 43.

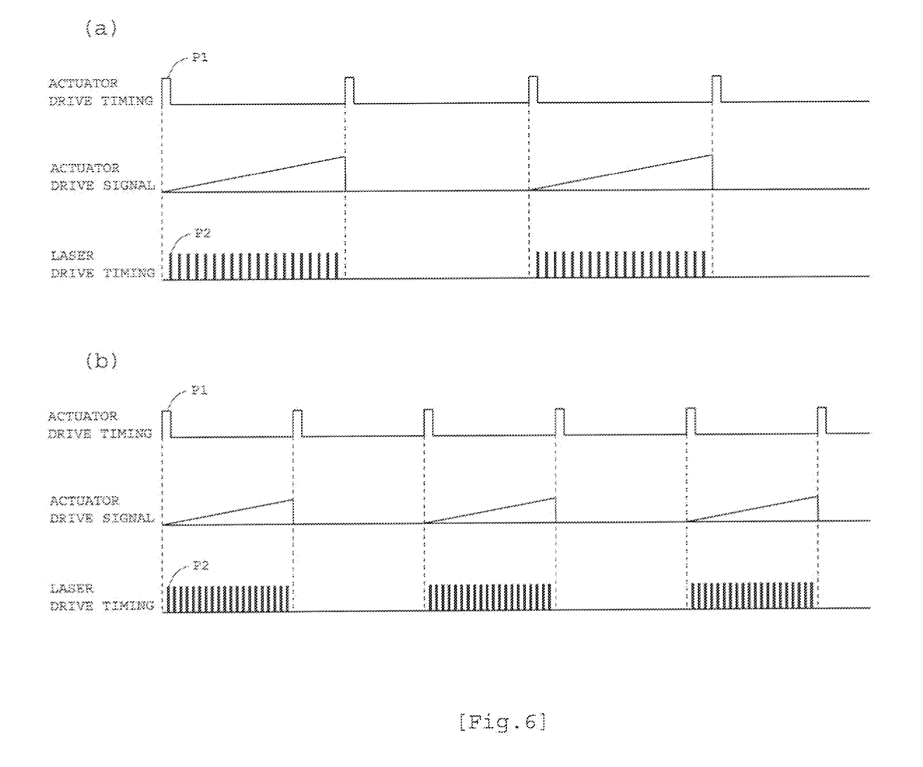

FIG. 6 is a diagram showing schematically a timing for driving the actuator and a timing for driving the laser: FIG. 6 (a) is a timing chart for projection in a normal screen size; and FIG. 6 (b) is a timing chart for projection in a reduced screen size.

As shown in FIG. 6 (a), a timing pulse P1 for driving the actuator 43b is output at a constant frequency. In synchronization with the timing pulse P1, a drive signal is output to the actuator 43b. In addition, in synchronization with the timing pulse P1, a timing pulse P2 for driving the laser portions 41a, 41b, and 41c is output by the number of horizontal pixels at a frequency corresponding to one pixel region. In synchronization with the timing pulse P2, a drive signal is output to the laser portions 41a, 41b, and 41c. This brings about operational synchronization between the actuator 43b and the laser portions 41a, 41b, and 41c, which allows the laser lights to be properly irradiated to each of the pixel regions. When the screen size is reduced, the frequency of the timing pulse P1 becomes shorter, and the frequency of the timing pulse P2 also becomes shorter accordingly, as shown in FIG. 6 (b).

Although, in FIG. 6, a drive signal of the actuator 43b is schematically represented as a simple rump signal, the drive signal actually constitutes a signal configured as to drive the mirror 43b two-dimensionally for horizontal laser light scanning.

In this embodiment, the projector module 4 is driven by power from the battery 600. Accordingly, if the projector module 4 is battery-operated, it is desired to suppress power consumption and lengthen an operating time (projecting time). Therefore, in this embodiment, the remaining level of the battery 600 is detected, and if the battery 600 becomes low in remaining level, the turning angle of the movable mirror 43 (turning range of the mirror 43a) is decreased to reduce a screen size. This makes it possible to decrease amounts of lights emitted from the laser portions 41a, 41b, and 41c of the light source part 41 and suppress power consumption at the projector module 4.

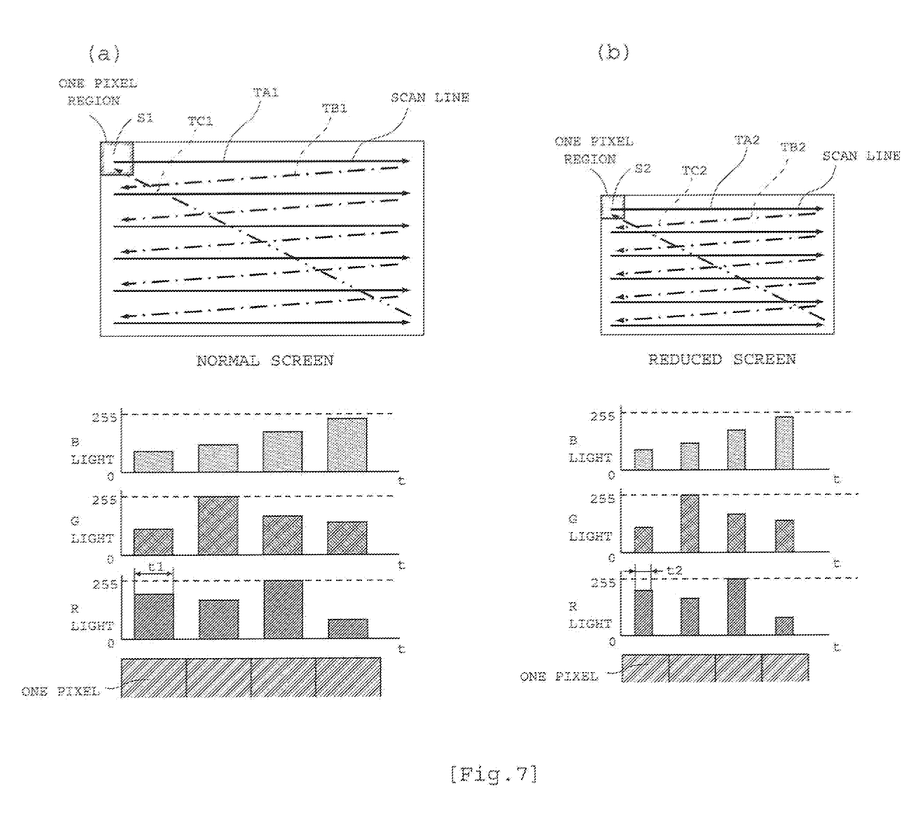

FIG. 7 is a diagram showing output states of the laser lights in a normal screen and a reduced screen: FIG. 7 (a) shows a configuration of the normal screen and output states of the laser lights in the normal screen; and FIG. 7 (b) shows a configuration of the reduced screen and output states of the laser lights in the reduce screen.

This embodiment has the normal screen of a predetermined size (e.g. about 7 inches) as shown in FIG. 7 (a). If the battery 600 is sufficiently charged, the movable mirror 43 is driven and controlled so as to form a turning angle in correspondence with the normal screen size (hereinafter, referred to as “normal turning angle”). In addition, in this embodiment, an irradiation time of laser lights in one pixel region is set for proper brightness in the normal screen size (hereinafter, referred to as “normal irradiation time t1”). The light source part 41 is driven and controlled so as to irradiate the laser lights to one pixel region for the normal irradiation time t1.

Meanwhile, if the battery 600 becomes low in remaining level, the screen size is reduced to about 50% of the normal screen (reduced screen), for example, as shown in FIG. 7 (b). If the screen is reduced, the screen becomes smaller in height and width by about 30% than the normal screen. Then, the scan lines become shorter by about 30%, and a distance between the scan lines also becomes shorter by about 30%. Accordingly, the movable mirror 43 is driven and controlled so as to form a turning angle smaller by about 30% in the horizontal and vertical directions than the normal screen (hereinafter, referred to as “small turning angle”).

At that time, the frequency of timing pulse P2 becomes higher with screen size reduction as shown in FIG. 6 (b), but the number of timing pulses P2 remains unchanged to thereby maintain the total number of pixels as it is. Accordingly, an area S2 of one pixel region in the reduced screen is reduced to about 50% of an area of one pixel region in the normal screen S1. In addition, the turning speed of the mirror 43a remains unchanged with screen size reduction, and therefore a scan time TA2, a horizontal return time TB2, and a vertical return time TC2 in the reduced screen become shorter by about 30% than a scan time TA1, a horizontal time TB1, and a vertical return time TC1 in the normal screen. Here, the term “scan time” refers to a time required for one scan line to be scanned with laser lights. The term “horizontal return time” refers to a time required for the mirror 43a to turn from an endpoint of a scan line to a start point of a next scan line. In addition, the term “vertical return time” refers to a time required for the mirror 43a to turn from an end point of a lowermost scan line to a start point of an uppermost scan line.

The brightness of a projection screen becomes higher with an increase in amounts of laser lights irradiated to a unit area. Accordingly, if the area of one pixel region is smaller by 50%, the same level of brightness can be obtained by irradiating a total amount of laser lights decreased by 50% to one pixel region. In consideration of this, if the screen is reduced, an irradiation time of laser lights for one pixel region can be decreased to about 50% of that in the normal screen.

However, since a laser light scanning operation is repeated during projection as stated above, if a time required for scanning one screen (scan time+horizontal return time+vertical return time) becomes shorter, a time interval between when laser lights are irradiated to one pixel region and when the laser lights are returned to the same pixel region becomes shorter accordingly. This causes the screen to feel brighter to a viewer. Therefore, if an irradiation time is set for the reduced screen only in consideration of a reduction of one pixel region, there is a possibility that a displayed image becomes brighter unnecessarily and power consumption cannot be reduced efficiently at the light source part 41.

In this embodiment, therefore, if the screen is reduced, an irradiation time of the laser lights is set for one pixel region in consideration of a decrease in light amount resulting from area reduction of the projection screen and a decrease in light amount resulting from shortening of a required time of laser light scanning, as shown in FIG. 6 (b). In this embodiment, the area of one pixel region is reduced to about 50%, and an irradiation time in the reduced screen (hereinafter, referred to as “short irradiation time t2”) is made further shorter than 50% of the normal irradiation time. Accordingly, when the screen is reduced, the light source part 41 is driven and controlled so as to irradiate the laser lights to one pixel region for the shorter irradiation time t2.

In such a manner, it is possible to reduce power consumption effectively at the light source part 41 while maintaining the brightness of the reduced screen at the same level as the brightness of the normal screen.

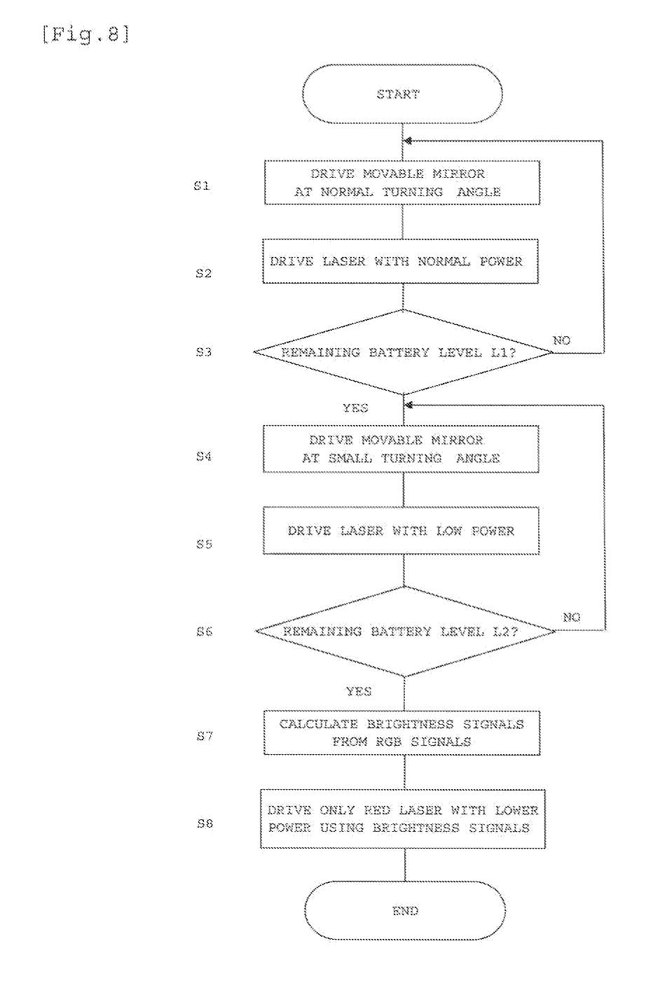

FIG. 8 is a flowchart showing a specific control operation for reducing power consumption at the projector module 4. The control operation will be described below in accordance with the flowchart.

When the projection mode is started, the projector is firstly operated in a normal mode. Specifically, the actuator control part 120 drives the movable mirror 43 so as to form a normal turning angle (S1). In addition, the image signal processing part 130 drives the light source part 41 so as to irradiate the laser lights with predetermined laser gradations for the normal irradiation time t1, in synchronization with the timing pulse P2 of the periods shown in FIG. 6 (a) (S2). Accordingly, an image of a normal screen size is projected onto the projection plane as shown in FIG. 7 (a).

Next, the remaining battery level determination part 150 determines whether a voltage detected by the BT detection part 710 has lowered to a preset remaining battery level L1 (S3). If the battery is sufficiently charged and the remaining battery level determination part 150 determines that the detected voltage has not reached the remaining battery level L1 (S3: NO), the projector operates continuously in the normal mode.

Meanwhile, when the battery becomes low in remaining level and the remaining battery level determination part 150 determines that the detected voltage has lowered to the remaining battery level L1 (S3: YES), the projector operates in a first low-power mode. Specifically, the actuator control part 120 drives the movable mirror 43 so as to form a small turning angle (S4). In addition, the image signal processing part 130 drives the light source part 41 so as to irradiate the laser lights with the predetermined gradations for the short irradiation time t2, in synchronization with the timing pulse P2 of the periods shown in FIG. 6 (b) (S5). Accordingly, an image of a reduced screen size is displayed on the projection plane as shown FIG. 7 (b).

Next, the remaining battery level determination part 150 determines whether a voltage detected by the BT detection part 710 has further lowered to a preset remaining battery level L2 (S6). The remaining battery level L2 denotes a voltage value lower than the remaining battery level L1. If the remaining battery level determination part 150 determines that the detected voltage has not reached the remaining battery level L2 (S6: NO), the projector operates continuously in the first low-power mode.

Meanwhile, if the battery becomes very low in remaining level and the remaining battery level determination part 150 determines that the detected voltage has lowered to the remaining battery level L2 (S6: YES), the projector operates in a second low-power mode. In the second low-power mode, an image is projected not with the use of all of the three R, G, and B lights, but with the use of a single color light. Firstly, the image signal processing part 130 retrieves brightness signals from the RGB signals using a predetermined conversion equation (S7). In addition, the image signal processing part 130 drives and controls only the red laser portion 41a, for example, in accordance with the brightness signals (S8). Accordingly, the projection plane is scanned using only the R light with the gradation in accordance with the brightness signals, and therefore an image of the reduced screen size is represented only in red color on the projection plane.

In the normal mode and the first low-power mode, scanning is performed for each screen using the R, G, and B lights in orderly sequence, as stated above. In the second low-power mode, however, scanning is performed by the movable mirror 43 using R light only. In this mode, for the times of scanning with the G and B lights, the green laser portion 41b and the blue laser portion 41c are not driven and only the movable mirror 43 is driven as in the first low-power mode.

In this embodiment, as described above, when the battery 600 becomes low in remaining level, the size of the projection screen can be reduced to thereby decrease an amount of light required for projection. This makes it possible to reduce an amount of laser light emission (irradiation time) and suppress power consumption at the light source part 41. As a result, it is possible to suppress power consumption at the projector module 4 and lengthen a projecting time.

Further, in this embodiment, an amount of laser light emission (irradiation time) to the reduced projection screen is set in accordance with the degree of reduction in area of the projection screen and a degree of shortening a time required for laser light scanning of one screen, which allows the brightness of the reduced projection screen to be close to the brightness of the normal projection screen. Accordingly, it is possible to suppress effectively power consumption at the light source part 41 while maintaining the brightness of a projected image at an almost equal level between before and after the screen reduction.

Moreover, in this embodiment, when the battery 600 becomes low in remaining level, numerical limitation is set to laser lights to be irradiated (the laser portions to be driven), and single-color projection is performed using only one laser light. This makes it possible to decrease an amount of light emission (irradiation time) from the light source part 41 and suppress power consumption at the light source part 41. As a result, it is possible to suppress power consumption at the projector module 4 and lengthen a projecting time.

Further, in this embodiment, out of R, G, and B lights, only R light with smallest consumption current is used for single-color projection, which makes it possible to further reduce power consumption.

In addition, if single-color projection is performed in accordance with one of RGB signals, an image cannot be clearly displayed. In this embodiment, however, brightness signals are retrieved from RGB signals and single-color projection is carried out in accordance with the brightness signals, and therefore an image can be displayed in a clear and easily viewable manner.

In this embodiment, only R light is used in the second low-power mode, and only the movable mirror 43 is driven for the times of scanning with G and B lights. However, this decreases significantly the brightness of the projection screen as compared with the case with emission of three lights. Accordingly, R light may also be used for image projection at the time of scanning with either G or B light, depending on the state of brightness of the projection screen, although the effect of reducing power consumption becomes somewhat smaller.

Alternatively, R light may be used for scanning at both the times of scanning with G and B lights. Even in this case, the effect of reducing power consumption can also be obtained as compared with the case of scanning actually with G and B lights, since R light is lower in power consumption than G and B lights.

Besides, the scan time of R light may be decreased stepwise in such a manner that: R light is emitted in accordance with brightness signals at the scan times of R, G, and B lights in the beginning of the second low-power mode; and when the power source becomes low in remaining level to such a degree, the emission of R light is stopped at the scan time of B light; and if the power source becomes further lowered in remaining level, the emission of R light is stopped at the scan time of G light, for example.

Although the embodiment of the present invention is as described above, the present invention is not limited to this embodiment. In addition, the embodiment of the present invention may be modified in various manners other than those described above.

For example, in the foregoing embodiment, an amount of laser light emission from the light source part 41 is adjusted by changing the irradiation times, but the method of adjustment is not limited to this and may be as described below.

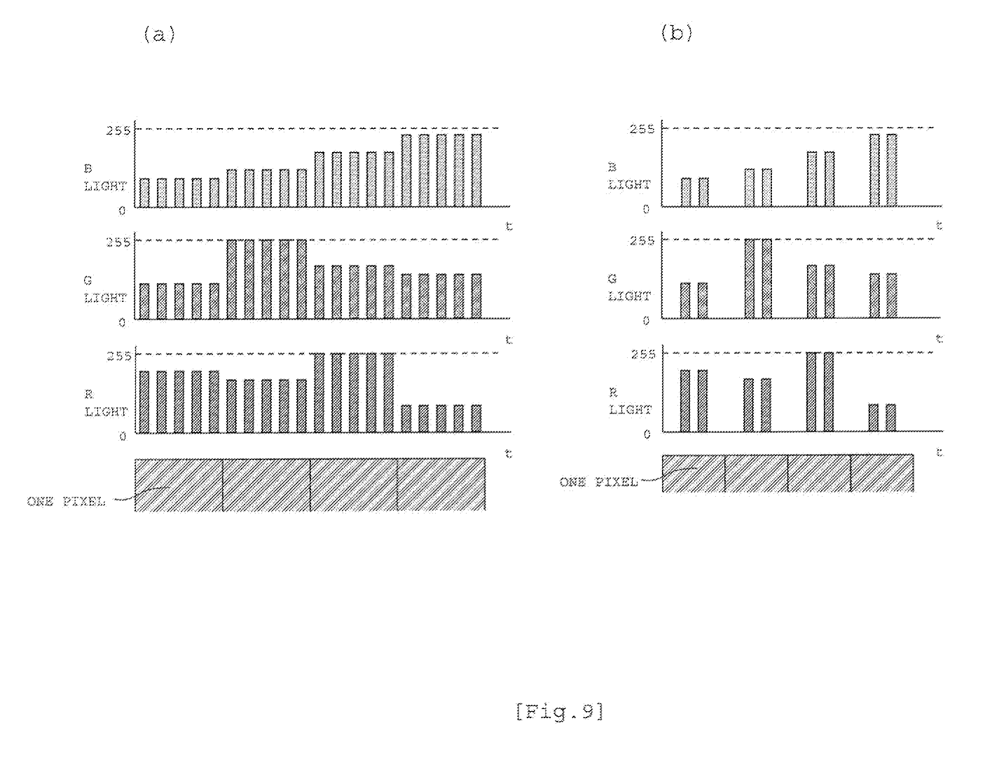

FIG. 9 is a diagram showing another example of configuration for adjusting amounts of emission of the laser lights: FIG. 9 (a) is a diagram showing output states of the laser lights in the normal screen; and FIG. 9 (b) is a diagram showing output states of the laser lights in the reduced screen.

In this configuration example, the laser portions 41a, 41b, and 41c are pulse-driven (pulses with specific widths are intermittently output), and the amounts of emission of the laser lights for one pixel region are adjusted by the number of pulses. In this case, when the projection screen is reduced, the number of pulses is decreased for one pixel region as shown in FIG. 9 (b).

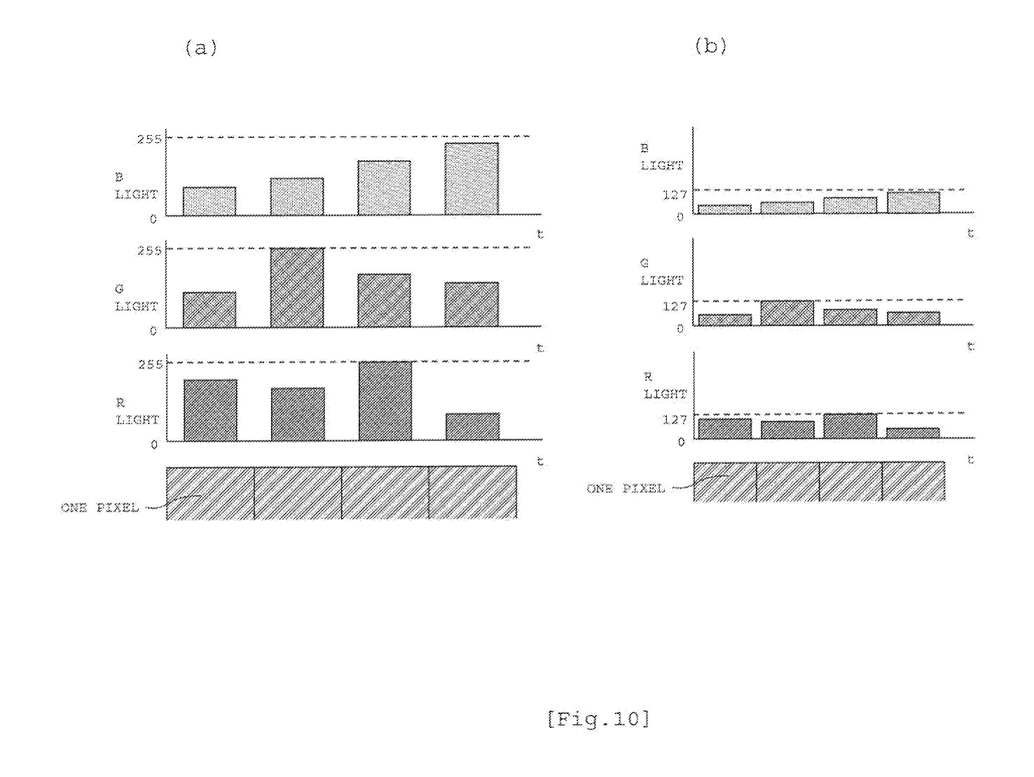

FIG. 10 is a diagram showing still another example of configuration for adjusting amounts of emission of the laser lights: FIG. 10 (a) is a diagram showing output states of the laser lights in the normal screen; and FIG. 10 (b) is a diagram showing output states of the laser lights in the reduced screen.

In this configuration example, the amounts of emission of the laser lights are adjusted for one pixel region by changing the magnitude of laser power. In this case, if the projection screen is reduced, laser power is lowered with the highest gradations as shown in FIG. 10 (b). Since lowering the laser power makes it hard to produce proper gradations, the numbers of levels of gradations may be each reduced to a half, that is, 128 levels, for example, as shown in FIG. 10 (b).

Further, in the foregoing embodiment, the screen size is reduced by decreasing the turning angle of the movable mirror 43 to narrow scan ranges of the laser lights, but the method for screen size reduction is not limited to this and may be as described below.

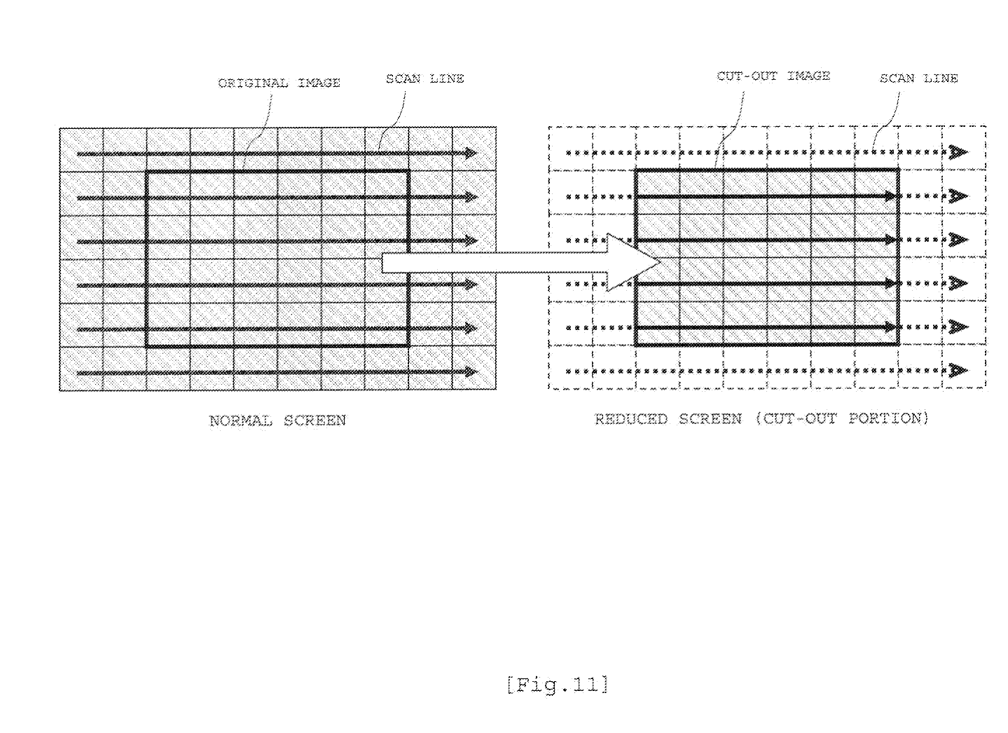

FIG. 11 is a diagram showing another example of configuration for reducing the size of the projection screen. In this configuration example, a portion of an image in the normal screen, for example, a central portion, is cut out and only the cut-out portion is projected onto thereby reduce the projection screen, as shown in FIG. 11. In this case, the area of one pixel region remains unchanged but the total number of pixels is decreased.

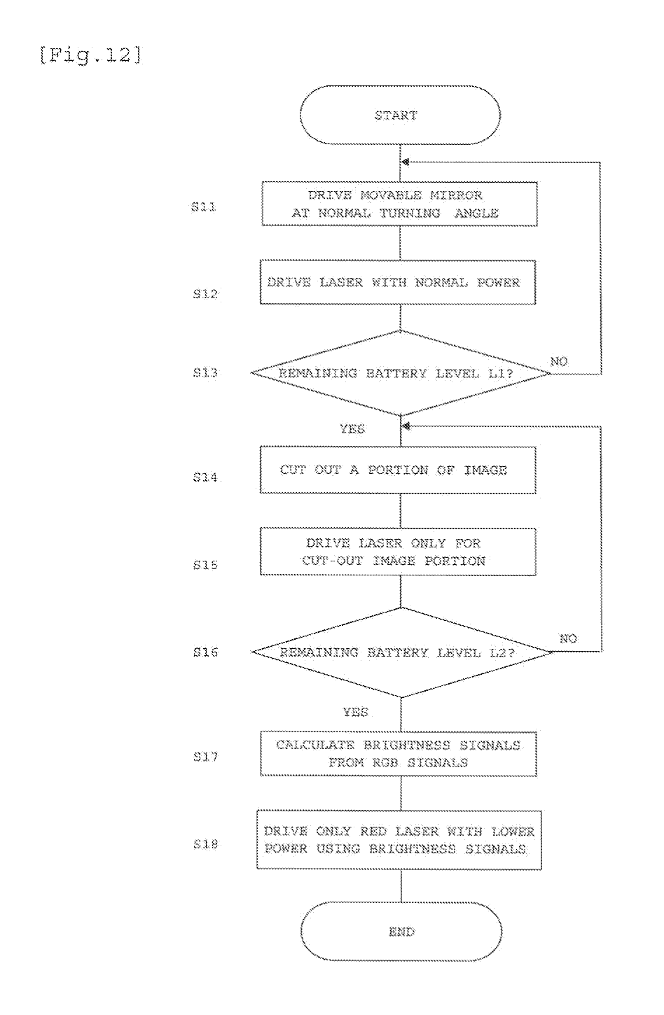

FIG. 12 is a flowchart of a specific control operation in the configuration example of FIG. 11. This control operation will be described below in accordance with the flowchart.

When the projection mode is started, the projector operates in the normal mode in the same manner as in the foregoing embodiment, until the voltage of the battery 600 reaches the remaining battery level L1 (S11 to S13). Accordingly, an image of the normal screen size is displayed on the projection plane as shown in the left part of FIG. 11.

Meanwhile, if the remaining battery level determination part 150 determines that the detected voltage has lowered to the remaining battery level L1 (S13: YES), the projector operates in the first low-power mode. Specifically, the image signal processing part 130 cuts out a central portion of the original image and generates an image signal for screen reduction (S14). At that time, the actuator control part 120 drives the movable mirror 43 at the normal turning angle.

Then, the image signal processing part 130 drives the light source part 41 so as to irradiate the laser lights only when the irradiation positions of the laser lights are located in the cut-out portion, in accordance with the image signal for screen reduction (S15). Accordingly, laser light scanning is carried out only for the cut-out portion, and only the movable mirror 43 is driven for the portions other than the cut-out portion. In this case, the area of one pixel region remains unchanged, and output states of the laser lights in one pixel region of the cut-out portion becomes the same as output states of the laser lights in the pixel region of the equivalent portion of the normal screen. As a result, a cut-out image of the reduced screen size is displayed on the projection plane as shown in the right part of FIG. 11. In this case, no laser lights are irradiated to pixels outside the cut-out portion (shown by broken lines in the right part of FIG. 11), and power consumption is reduced at the light source part 41 accordingly.

The cut-out portion of an image is not limited to the central portion as described above, and may be located in any position. For example, in the case of a moving image, a most active portion may be detected and cut out from the image.

Next, if the battery becomes very low in remaining level and the remaining battery level determination part 150 determines that the detected voltage has lowered to the remaining battery level L2 (S16: YES), the projector operates in the second low-power mode as in the case of the foregoing embodiment (S17 and S18). Accordingly, an image of the reduced screen size is displayed only in red color on the projection plane.

In this configuration example, when the battery 600 becomes low in remaining level, a portion of the original image is cut out, and an image of the cut-out portion is projected. At that time, the turning range of the movable mirror 43 is not changed and therefore the time required for scanning one screen also remains unchanged. In addition, the area of one pixel region is not changed and therefore the amounts of the laser lights irradiated to one pixel region also remain unchanged. However, since the total number of pixels in the projection screen is decreased, power consumption at light source part 41 can be reduced accordingly.

In addition, in this configuration example, since it is not necessary to make a change to drive control of the movable mirror 43, it is possible to reduce power consumption at the projector module 4 by a comparatively simple control operation.

Further, in the foregoing example, out of the three laser lights, only R light with lowest power consumption is used in the second low-power mode. However, the used color (laser light) is not limited to this and may be made selectable.

For example, a histogram or the like may be used to analyze the colors used in an image projected at that time, so that the image signal processing part 130 may select most-used one of the colors. Alternatively, the image signal processing part 130 may select the color chosen by the user through key operation or the like.

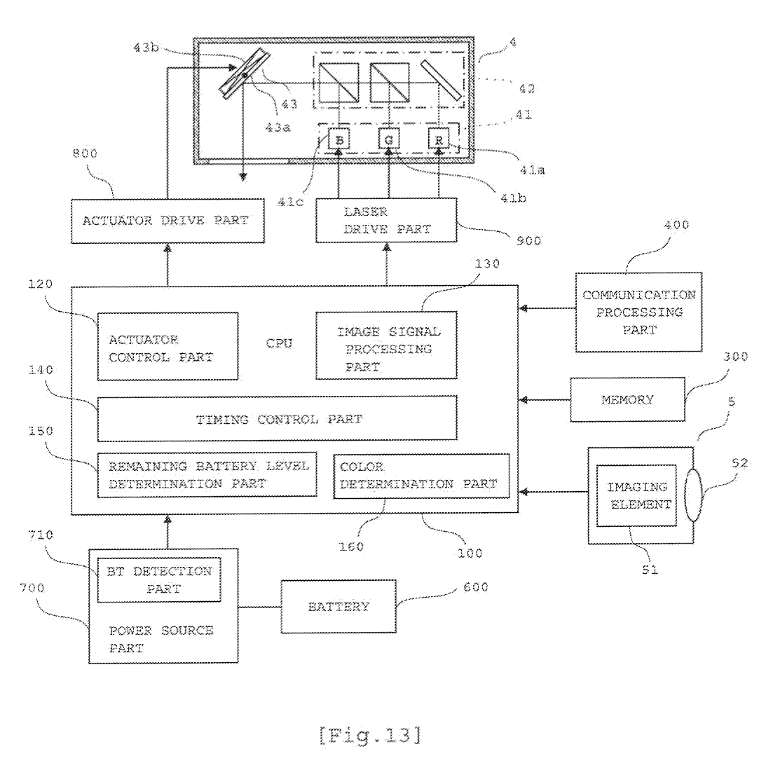

Further, the camera module 5 may be used to shoot a wall or the like as a projection plane, so that the image signal processing part 130 selects one of the three colors that is considered as most easily viewable in an image projected onto the projection plane (for example, a color most distant in tone from an average of the colors of the projection plane) and then an image is projected using this color. In this case, the CPU 100 comprises a color determination part 160 for determining a color of an image captured by the imaging element 52, as shown in FIG. 13. Then, the color determination part 160 determines the colors of the projection plane, and sends the information of the colors to the image signal processing part 130. This allows the projected image to be more easily viewable.

Further, in the foregoing embodiment, an image is entirely projected by a single color (R light) for one screen in the second low-power mode. However, the operation in the second low-power mode is not limited to this, and the color to be used may be changed for each region of the screen (including a pixel unit). In this case, if a small number of colors are used as the case of a graphic image, the used colors may be replaced by colors capable of being represented by one laser light, such as red, green, or blue, to form the image only with those colors. Accordingly, at least only one laser light is irradiated for one pixel, and therefore it is possible to obtain the effect of reducing power consumption as in the case of projecting one whole screen with one laser light.

Alternatively, in the case of an image with a small number of colors, the colors of the image may be replaced by colors capable of being represented by two laser lights, so that the image is projected using only the two laser lights, although the effect of reducing power consumption becomes somewhat smaller.

In the foregoing embodiment, it is assumed that the scanning speed of the laser lights remains unchanged between before and after a screen size reduction. Alternatively, the scanning speed of the laser lights may be lowered in accordance with a screen size reduction so that the brightness of the screen is almost equal between before and after the screen size reduction.

In addition, in the modified example of FIG. 11, the scan range of the laser lights is equal between before and after screen size reduction. Alternatively, only the reduced screen region may be scanned with the laser lights.

Besides, the light source part 41 may be formed by another light emitting element such as a light emitting diode (LED), for example.

In addition, the embodiment of the present invention may be appropriately modified in various manners within the scope of a technical idea recited in the claims.

1. A projection device, comprising:
a light source part;
a scan part for scanning a projection plane with light emitted from the light source part;
a light source control part for driving the light source part in accordance with an image signal;
a scan control part for driving the scan part; and
a remaining battery level determination part for determining a remaining level of a battery as a power source, wherein
when the remaining battery level determination part determines that the remaining level of the battery has lowered to a first predetermined level, the light source control part and the scan control part control driving of the light source part and the scan part so as to reduce a size of a screen projected onto the projection plane.

2. The projection device according to claim 1, wherein
when the battery becomes low in remaining level to the first predetermined level, the scan control part narrows a scan range in correspondence with a decreased screen size.

3. The projection device according to claim 2, wherein
the light source control part drives the light source part so as to decrease an amount of light irradiated to each pixel region in a projection image of the reduced screen size.

4. The projection device according to claim 3, wherein
the light source control part reduces the amount of light irradiated to the pixel region, in accordance with a degree of reduction in area of the pixel region and a degree of shortening of a time required for scanning one screen by narrowing the scan range.

5. The projection device according to claim 1, wherein
the light source control part and the scan control part drive the light source part and the scan part so as to display a portion of a full-sized image in the reduced screen region.

6. The projection device according to claim 5, wherein
the scan control part drives the scan part so as to make a light scan range on the projection plane equal between before and after the screen size reduction, and
after the screen size reduction, the light source control part drives the light source part only with a timing corresponding to the reduced screen.

7. The projection device according to claim 1, wherein
the light source part is configured to emit a plurality of color lights,
the scan part scans the projection plane with the plurality of color lights emitted from the light source part to thereby project an image with a screen size in accordance with the scan range onto the projection plane, and
when the remaining battery level determination part determines that the battery has lowered in remaining level to a second predetermined level lower than the first predetermined level, the light source control part drives the light source part so as to decrease the number of the color lights for scanning the projection plane.

8. The projection device according to claim 7, further comprising:
a selection control part selecting color light(s) for scanning the projection plane from among the plurality of color lights.
